(19) United States
(12) Patent Application Publication
(10) Pub. No.: US 2016/0216969 A1
(43) Pub. Date: Jul. 28, 2016

(54) SYSTEM AND METHOD FOR ADAPTIVELY MANAGING REGISTERS IN AN INSTRUCTION PROCESSOR

(71) Applicant: QUALCOMM Incorporated, San Diego, CA (US)

(72) Inventors: Dario Suarez Gracia, Palo Alto, CA (US); Behnam Robatmili, San Jose, CA (US)

(21) Appl. No.: 14/607,270

(22) Filed: Jan. 28, 2015

(51) Int. Cl. G06F 9/30

(52) U.S. Cl. CPC G06F 9/30109; G06F 9/30141

(57) ABSTRACT

Systems and methods for adaptively managing registers in an instruction processor are disclosed. The system identifies one or more registers with inoperable cells. An operand manager identifies a set of operable cells within the one or more registers with inoperable cells and determines if a present instruction will use an operand that can be supported by the set of operable cells. When the set of operable cells can support the operand, the operand manager generates an assignment which is communicated to a register file manager.

### TECHNICAL FIELD

The present disclosure relates generally to systems and methods for managing registers in instruction processing systems.

### DESCRIPTION OF THE RELATED ART

As early as 1965, Gordon E. Moore observed that the number of circuit devices (e.g., transistor, resistor, capacitor, diode) in an integrated circuit doubles approximately every two years. Moore attributed this to the log-linear relationship between circuit complexity and time. Moore's analysis was directed at the density of transistors at which cost is minimized,

In 1974, Robert H. Dennard observed that as transistors were made smaller through advances in photolithography, their power density remains constant, so power usage is proportional to integrated circuit area. According to Dennard, as transistor dimensions are reduced and with both voltage and current being proportional to length for transistors, performance per Watt would grow at roughly the same rate as transistor density. As transistor dimensions are reduced by 30% and input voltages are reduced to keep the electric field constant, power consumption is reduced by 50%, Therefore, with each generation of processor, the transistor density doubles, the circuit becomes 40% faster, while power consumption remains the same.

However, since about 2005, Dennard scaling no longer appears to be applicable as for smaller transistor sizes, current leakage and temperature become problematic. Both current leakage and heat contribute to a reduction in energy efficiency. In addition, operating voltages can no longer be reduced without increasing, permanent and transient errors in integrated circuits.

The breakdown in Dennard scaling has led a number of integrated circuit designers to develop multi-core processors. The addition of more processors certainly increases chip performance. However, unless the power consumed per instruction is reduced, there will still be an increase in power density. In addition, multicore processors have proved to be difficult to program and have failed to reach their utilization potential.

### SUMMARY

An embodiment of an instruction processing system that adaptively manages operable storage cells includes a set of available registers and an operand manager. The set of available registers includes N members of M cells, where N and M are positive integers, and where at least one of the M cells of an identified member register of the set of N registers is inoperable. The operand manager identifies a set of operable cells in the identified member register and determines if the set of operable cells in the identified member register can support an operand. In response to determining that the set of operable cells in the identified member register can support the operand, the operand manager generates an assignment that logically couples the set of operable cells to the operand and notifies a register file manager of the assignment. Otherwise, when the set of operable cells cannot support the operand, the system selects the next available register with a complete set of operable cells.

An embodiment of a method for adaptively managing registers in a processor includes locating at least one member register from a set of available registers having at least one inoperable cell among the cells forming the at least one member register; identifying a set of operable cells in the at least one member register that has at least one inoperable cell; in response to an indication that an operand can be supported by less than a nominal number of cells, determining if the set of operable cells in the at least one member register that has at least one inoperable cell can support the operand; and in response to determining that the set of operable cells can support the operand, generating an assignment that logically couples the set of operable cells to the operand, and notifying a register file manager of the assignment. Otherwise, when the set of operable cells cannot support the operand, selecting the next available register from the set of available registers having all operable cells.

These and other features and advantages of an improved instruction processing system and a method for adaptively managing registers in the instruction processing system will become apparent from the following description, drawings, and claims.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a schematic diagram illustrating an embodiment of an instruction processing system.

FIGS. 2A-2C each includes respective schematic diagrams illustrating the operability of individual cells in the set of available registers of the instruction processing system of FIG. 1.

FIG. 3 is a schematic diagram illustrating an embodiment of the operand manager of FIG. 1.

FIG. 4 is a flow chart illustrating an embodiment of a method for allocating operands to sets of operable cells in the operable registers of FIGS. 2A-2C.

FIG. 5 is a schematic diagram illustrating a collection of sets of operable cells available to support modified or short operands with the operand manager of FIG. 3.

FIG. 6 is a flow chart illustrating an embodiment of a method for adaptively managing registers in the instruction processing system of FIG. 1.

### DETAILED DESCRIPTION

The term “exemplary” is used herein to mean “serving as an example, instance, or illustration.” Any aspect described herein as “exemplary” is not necessarily to be construed as preferred or advantageous over other aspects.

In this description, the phrase “instruction processing system” is used to describe a hardware element capable of accessing and executing machine level instructions. Non-limiting examples of instruction processing systems include a “central processing unit (“CPU”),” “digital signal processor (“DSP”),” “graphical processing unit (“GPU”),” an application specific integrated circuit (“ASIC”), etc. Moreover, a CPU, DSP, GPU, ASIC, etc. may be comprised of one or more distinct processing components generally referred to as “core(s).”

In this description, “machine level instructions” are fetched and executed directly by a processing unit such as a CPU, GPU, etc. Each instruction performs a very specific task, such as a load, a jump, or an arithmetic logic unit operation (e.g., add, subtract, multiply, increment, decrement, OR, AND, NOT, XOR, . . . ) on a unit of data in a register or in an addressable memory.

The term “contiguous cells” is used to refer to a series of adjacent bit storage elements in an addressable register.

The term “operand” is used to refer to data or an address.

The term “inoperable cell” is used to refer to a separate storage element in a physical register that is incapable of being controllably set to a condition or unable to maintain a condition indicative of a logical value. An inoperable cell may be energized or de-energized.

In contrast, an “operable cell” is a storage element that is energized, capable of being controllably set to a desired condition, and maintains the desired condition indicative of a logical value as long as the element remains energized.

The term “register file” is used to refer to an array of physical registers that contains the general-purpose registers of the instruction processing system.

The term “register file manager” is used to refer to renaming logic and/or additional interfaces that manipulate operands in the general-purpose registers of the instruction processing system.

In addition, “content” when associated with an operable cell, is used to identify a logical value (e.g., a two-state cell supports a logical value of “1” or “0”). The term “content” may also include groups of contiguous cells that form a digital word. As is known, digital words can be further combined to form instructions, and a series of instructions used to generate executables, such as: object code, scripts, byte code, markup language files, etc.

As used in this description, the terms “logic,” “map,” “element,” “module,” and the like are intended to refer to items enabled in hardware via circuits and combinations of circuits.

Such hardware implementations may include any or a combination of the following technologies, which are all well known in the art: discrete electronic components, discrete logic circuit(s) having logic gates for implementing logic functions upon data signals, an application specific integrated circuit having appropriate logic gates, a programmable gate array(s) (PGA), a field programmable gate array (FPGA), etc.

The improved instruction processing system may be integrated in an embedded system or controller that operates under the direction of firmware or may be integrated in a computing device in any of a number of various form factors. However arranged, the computing device may be enabled in operational modes using hardware, a combination of hardware and firmware, a combination of hardware and software in execution, or a combination of hardware, firmware and software in execution.

Consequently, an improved instruction processing system may be operated in conjunction with configuration information and an executable, a thread of execution, a program, and/or multiple programs. These components may execute from various computer-readable media having various data structures stored thereon. The components may communicate by way of local and/or remote processes such as in accordance with a signal having one or more data packets (e.g., data from one component interacting with another component in a local system, distributed system, and/or across a network such as the Internet with other systems).

Improvements in the management of registers in an instruction processing system are illustrated and described. A register file (e.g., data stored in circuits) and register file manager (e.g., circuits or hardware) are fundamental components in instruction processing systems. An instruction set or instruction set architecture defines the basic items related to programming An instruction set includes or defines native data types, commands, registers, addressing modes for memory, interrupt and exception handling, and external input/output. A significant portion of the overall power consumed by an instruction processing system is related to the storage and management of values in registers. The size in number of bits, of each register is defined by the architecture of the processing system. For example, an Intel i5 processor has a set of 64-bit integer registers, a second set of 80-bit floating point registers, and a third set of 128-bit vector registers. By way of further example, an ARM v7 compatible processor has a set 32-bit integer registers and a set of 64-bit floating point registers.

When an instruction is decoded, renaming logic in the register file manager pairs a logical output register from the instruction with a physical register. The renaming logic tracks the physical register until another instruction directs the instruction processing system to overwrite the contents in the physical register or the register is released back to a pool of available physical registers.

However, most stored values are significantly smaller than what can be stored in the assigned or paired register. This variability in the size in bits required to support stored values in registers of an instruction processing system provides an opportunity to reduce the power consumed by such a system.

A number of embodiments are possible and envisioned. In a first embodiment, a voltage regulator can be used to reduce the voltage applied to a set of available registers. This can be accomplished in a controlled manner until a desired voltage level is reached. As a result, some of the cells within a register or registers in the set of available registers will no longer store or hold an appropriate voltage. These particular cells are deemed inoperable and if used by an instruction processing system will lead to errors. Stated another way, one or more inoperable cells within a register render the collection of cells unfit for use as a conventional register with a full complement of the designed number of bits. However, some portion of the cells will likely continue to operate nominally at this lower operating voltage. A map of the inoperable cell locations can be provided to an operand manager. The operand manager can use one or more external sources to identify operands that can be supported by less than a full complement of operable cells. In response, and in accordance with, a desired or expected number of cells to support the operand, the operand manager pairs a set of operable cells selected from the map with the operand and notifies the renaming logic of the assignment.

In an alternative embodiment, the voltage regulator may be directed to lower the operating voltage provided to the set of available registers until a desired number of inoperable cells is detected. The supply voltage adjustment in this case would be made without additional information.

In other alternative embodiments, the voltage regulator may be controllably adjusted to provide an increase or a decrease in the operating voltage (i.e., a variable supply voltage) to the registers based on the number of contiguous operable cells of various lengths available to support modified or short operands. Additionally, such adjustments might also be considered in light of analysis of a particular application and the likelihood of a need for shortened operand support.

In still another alternative embodiment, a controller may be deployed to de-energize a select number of cells in a desired number of registers to achieve a desired power savings. In this arrangement, the controller may provide configuration information or signals indicative of an array of cells that were de-energized to the operand manager. Such an array can define a set of operable/inoperable cells in a single physical register or a set of similarly positioned operable/inoperable cells in two or more of the available physical registers.

Each of the described embodiments can achieve reductions in power consumption during various stages of a processor pipeline. For a processor pipeline that includes fetch, decode, rename, issue, execute, write back and commit stages, the disclosed operand manager may be arranged with circuits responsive to a number of sources that determine at the decode stage whether a present instruction will produce an operand with a small value. When the determination is affirmative, the operand manager may mark the instruction as a candidate for a modified or short register. At the rename stage, an instruction that has been marked as a candidate for a modified or short register may be paired with a set of contiguous operable cells from a member of the set of available registers. In this regard, the operand manager communicates the pairing or assignment to the register file manager. At write back, if the operand manager receives a signal indicative of an overflow condition, the operand manager releases the assigned or paired set of contiguous operable cells and reassigns a larger set of contiguous cells. Alternatively, the operand manager may signal the register file manager to use a full-size register from the set of available registers. At the commit stage, the physical register entry is de-allocated or released.

In an example embodiment, the operand manager maintains a list of available sets of contiguous operable cells by the number of contiguous cells. When an instruction identifies a candidate operand and P bits are desired, where P is an integer less than M, the operand manager uses the list to identify an available register with a set of operable cells that can be used to support the operand. When no registers are available that can support P bits, the operand manager may assign a register with a set of operable cells in a number greater than P, including a register with a full set of M operable cells.

In accordance with the improved instruction processing system, an operand manager is provided. The operand manager is coupled to the set of available registers having one or more inoperable cells. When so arranged, the operand manager includes a cell analyzer that detects inoperable cells and generates a map or report that identifies registers with inoperable cells and the location of the operable cells, the inoperable cells, or both operable and inoperable cells. Alternatively, the operand manager receives the map or identifying information from an external cell analyzer.

In an example embodiment, the operand manager, responds to a decrease in the supply voltage that exceeds a threshold amount by directing the cell analyzer to recheck nominal operation of the cells. The instruction processing system is suspended until the updated map or list of inoperable cells is available to the operand manager. Thus, the operand manager is responsive or sensitive to changes in the supply voltage provided to the physical registers in the instruction processing system.

The operand manager is also coupled to a decoder, a register file manager, and to an arithmetic logic unit. The operand manager uses instructions and other information from these elements when determining how to appropriately pair a register with a set of operable cells and a set of inoperable cells. For example, the operand manager may use the present instruction in the current instruction register to analyze the immediate operands. An immediate operand that includes a value (e.g., an integer) that can be supported in less than M bits is a candidate to be supported by a physical register with less than a complete set of operable cells.

In addition, the operand manager may use the current value of a register to determine that the register is a candidate to be supported by a register with less than a complete set of operable cells. The operand manager can use information from the register file manager to make such a determination. For example, the current instruction register of the instruction processing system may include an instruction that directs the register file manager to move the content in a first register to a second register. When the content in the first register includes a value that can be supported in less than M bits, the second register is a candidate to be supported by a physical register with less than a complete set of operable cells.

Furthermore, the operand manager receives an indication of an overflow condition in an output register designated to support a write back execution stage. An overflow condition occurs when a calculation produces a result that is greater in magnitude than that which an identified register or storage location can store or represent. The operand manager responds to the overflow by signaling the register file manager that a remapping operation is in order. In some arrangements, the operand manager forwards the identity of a candidate physical register with the remapping signal. Alternatively, the register file manager upon receipt of the remapping signal may assign the next available register having a full set of operable cells to support the output from the arithmetic logic unit.

The improved instruction processing system can be used with architectures that support debugging features. For example, for architectures that provide in system programming support that enable a user to controllably map or assign an input value that was previously supported by a set of operable cells in a register with one or more inoperable cells, the operand manager will identify when such a mapping or assignment includes an input value that is too large to be supported by the set of operable cells. When this is the case, the operand manager will direct the register file manager to remap the input value to an appropriate register or will identify an appropriate set of operable cells from a different register to support the input value.

A modified compiler arranged to support an improved instruction processing system as described above generates encoded instructions that indicate when the operand manager should apply or assign a physical register with less than a complete set of operable cells to support an operand resulting from the encoded instruction. Such encoded instructions may include an indication of a desired and/or a minimum number of cells to support the operand. The operand manager assigns a physical register to the operand by logically coupling the set of operable cells in the physical register to the operand and communicating a signal or signals to the register file manager. Otherwise, when the operable cells in the set of available registers cannot support the operand, the operand manager may select the next available register from the set of available registers having a full set of operable cells. Alternatively, the operand manager may simply rely on the renaming logic provided in the register file manager to assign the next available register.

As briefly described, many of the disclosed functions can be enabled in conjunction with register renaming logic (e.g., circuits) to extend the flexibility and functionality of an instruction processor. While conventional register renaming techniques enable out-of-order execution by shifting use of directly named registers (i.e., registers defined in the assembly code) to additional physical registers to provide sequence control or parallelism, the present techniques when appropriately applied repurpose operational bits of an otherwise inoperative register to enable the instruction processor to continue to provide accurate results under low input voltage conditions. Note that the present circuits and techniques can be applied to improved register renaming logic to support the identification, management and use of reduced size physical registers (registers other than logical/architectural registers) in an instruction processing system.

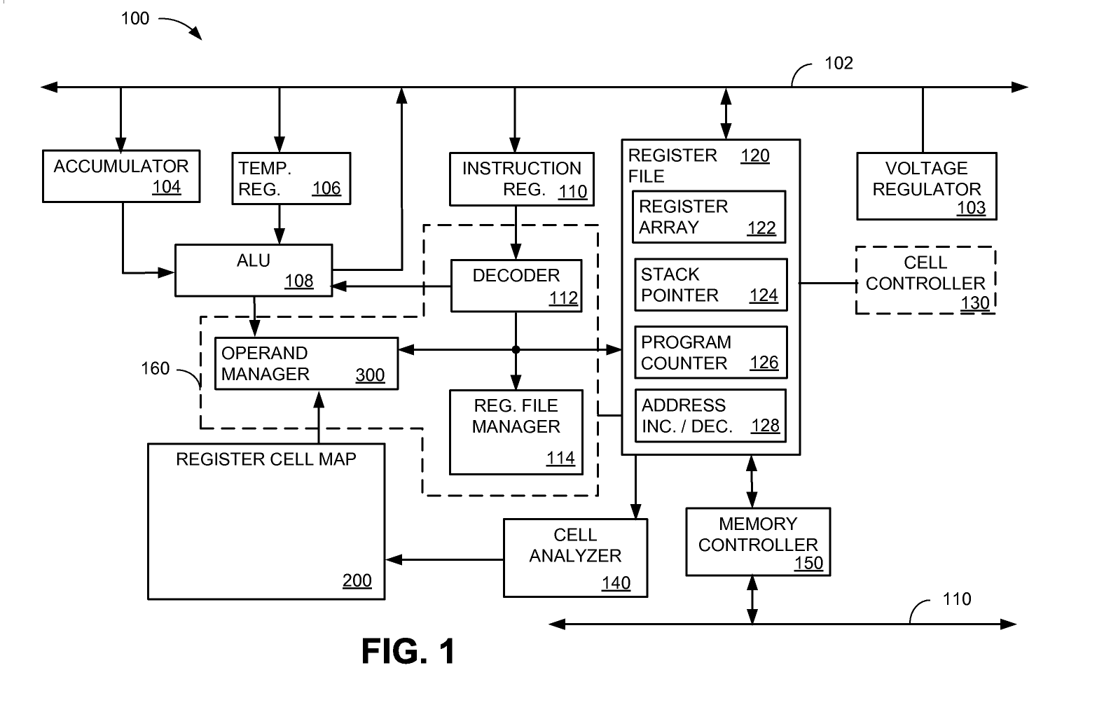

Attention is now directed to the illustrated embodiments of the improved instruction processing system and its components as shown in FIGS. 1-6. FIG. 1 is a schematic diagram illustrating an exemplary embodiment of an instruction processing system 100. As illustrated, the various elements of the instruction processing system 100 are connected to one another via a bus 102 that conveys commands, data and power to several of the functional circuits or elements. Although several elements including the decoder 112, register file manager 114, operand manager 300, as well as, the cell controller 130, cell analyzer 140, memory controller 150 and register cell map 200 are not shown with a direct connection to the voltage regulator 103 via the bus 102, distributing a regulated input voltage as provided by the voltage regulator 103 or a similar circuit element(s) is, in light of this disclosure, within the skill level of a person having ordinary skill in the art of microprocessor circuit design.

An instruction register 110 is arranged to identify instructions when they are present on the bus 102. The instruction register 110 is coupled to a decoder 112, which identifies the designated operation and is arranged to communicate the same to the arithmetic logic unit 108, the register file manager 114, the register file 120, and the operand manger 300. The arithmetic logic unit (ALU) 108 is a circuit or collection of circuits arranged to perform operations on the information provided in the accumulator and/or the temporary register 106 in accordance with information received from the decoder 112. The ALU 108 may include a control unit which generates the necessary signals to carry out or perform the instruction. The result of the designated operation is stored in the accumulator 104 and is available for later transfer to one of the designated registers in the register array 122 of the register file 120. The register file manager 114 includes circuits for directing and coordinating information stored in the register file 120. In this regard, the register file manager 114 includes logic for updating the stack pointer 124, the program counter 126, and a memory address increment/decrement register 128.

A memory controller 150 allows data transfers to and from storage coupled to the memory bus 110, which may be coupled to one or more random-access memory circuits (volatile memory) and one or more flash memory circuits or elements (non-volatile) both not shown in FIG. 1.

The cell controller 130 is an optional circuit or circuits that controllably de-energize or otherwise render a desired number of contiguous cells of select registers within the register array 122 inoperable. The cell controller 130 may function in accordance with one or more signals from a device controller or other device or mechanisms external to the instruction processing system. In this regard, the cell controller 130 provides a mechanism to controllably reduce the power consumed in processing instructions with the various registers provided in the register array 122.

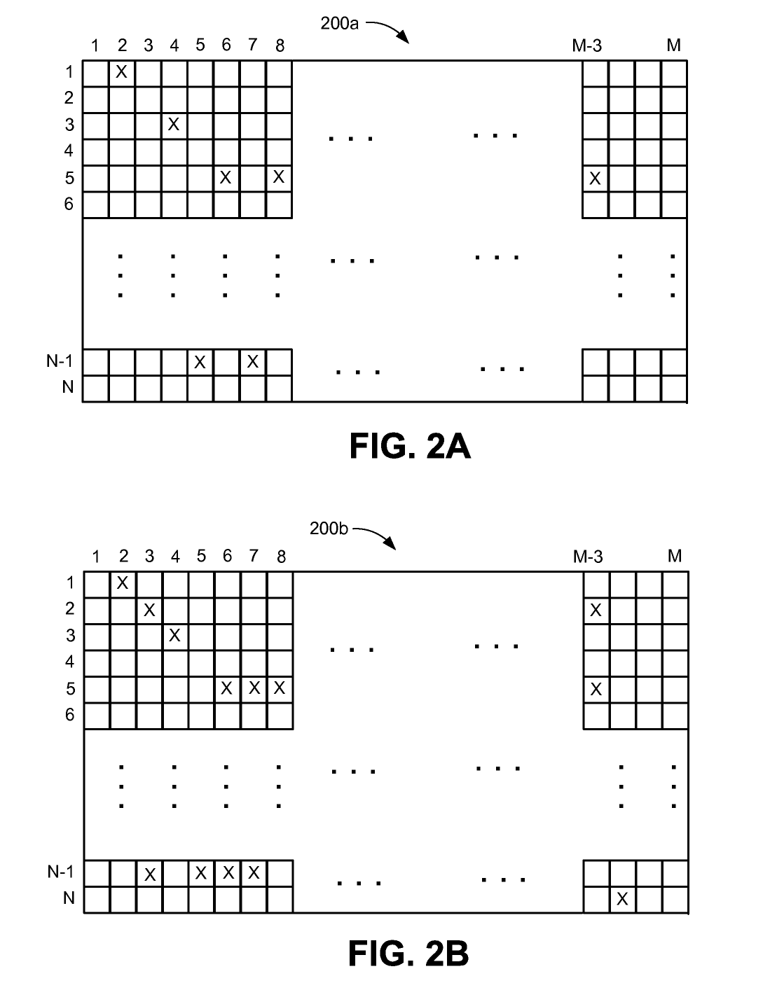

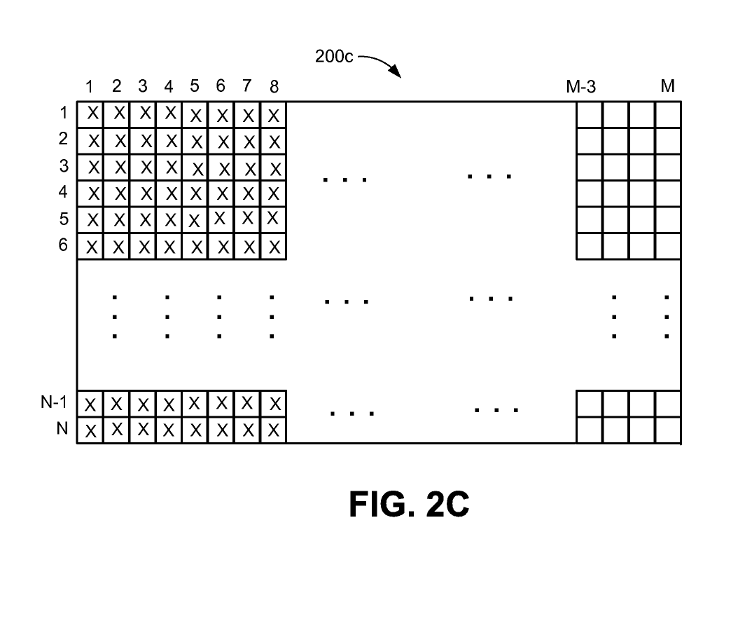

A register cell analyzer 140 includes circuits arranged to identify whether individual cells or bit locations within the registers of the register array 122 are operable and/or inoperable under present conditions. As described, the register cell analyzer 140 may respond to a signal or other indicia responsive to the supply voltage crossing a threshold value. When this is the case, the signal or other indicia may be forwarded to the decoder 112, the ALU 108, and the register file manager 114 to controllably suspend the processing of instructions. When enabled, the register cell analyzer 140 identifies the operable and/or inoperable storage cells for each of the registers in the register array and provides or stores the information in the register cell map 200, which is described in example embodiments in conjunction with FIGS. 2A-2C.

Although the example embodiments do not illustrate or expressly describe the use of the cell controller 130 in conjunction with the register cell analyzer 140, register cell map 200 and operand manager 300, such combinations are, in light of this disclosure, within the skill level of a person having ordinary skill in the art of microprocessor circuit design.

As further illustrated in FIG. 1, the operand manager 300 receives the information in the register cell map 200 and uses the same in conjunction with the register file manager 114 and the register file 120 to expose and use reduced cell registers that use one or more of the separate operable cells identified from within an inoperable register.

FIGS. 2A-2C each includes respective schematic diagrams illustrating the operability of individual cells in the set of available registers of the instruction processing system 100 of FIG. 1. For example, FIG. 2A includes a representation or map 200a of N registers of M bits, where both N and M are positive integers. The map 200a is a record of the bits or storage locations that are both operative (unmarked) and inoperative (marked) at the present input voltage provided by the voltage regulator 103 (FIG. 1). A first register represented by the top or uppermost row of N registers (i.e., row 1, as labeled on the left-hand side) includes an inoperable cell in the second cell location from the left, indicated by the column label “2”, while each of the remaining M-1 cell locations of the register are operable. Thus, the first register is capable of supporting a flag or bit in the first cell location from the left or a reduced cell register with M-2 or less bits in the operable cells to the right of the inoperable cell location.

In one embodiment, a single reassignment of the first register from an M-bit register to other than an M-bit register is enabled. In this embodiment, if the bit locations 3 through 10 are reassigned to support the storage of an operand that requires a byte to represent the operand, the remaining operative storage locations in locations 1 and 11 through M are not reassigned.

In an alternative embodiment, the M-2 bits of operable cells to the right of the inoperable cell location may be assigned or allocated as a reduced cell register ranging from a single bit up to M-2 bits. When allocated as a single bit, M-2 single bits or flags can be supported, as needed or desired. When allocated as multiple bit reduced cell registers, a combination of reduced cell registers and bit lengths are possible. For example, when M is the integer 32 and an inoperable bit is located in the second bit position, a total of 30 bits may be allocated to a single register or subdivided as may be desired. In some arrangements, the subdivisions may be determined based on factors of the integer 2. In other arrangements, the subdivisions may be determined based on predicted requirements for bit lengths or by use of other mechanisms.

As further shown in FIG. 2A, a third register represented by the third row from the top (i.e., row 3, as labeled on the left-hand side) includes an inoperable cell in the fourth cell location from the left, while each of the remaining M-1 cell locations are operable. Thus, the third register is capable of supporting three single bit storage locations, a single three-bit storage register, or a combination of a single bit storage location and a two-bit storage register in the cells left of the inoperable cell. In addition, the third row is further capable of supporting an M-4 reduced cell register in the operable bits to the right of the inoperable cell. As indicated above, the M-4 operable cell locations can be subdivided and allocated as desired.

A fifth row from the top (i.e., row 5, as labeled on the left-hand side) includes inoperable cells in the 6^{th}, 8^{th}, and M-3 bit positions from the left. Accordingly, the cells or bits defined by column labels 1-5, 7, 9 through M-4, and the remaining storage locations are operable and available for assignment as desired.

A second to last row (i.e., row N-1, as labeled on the left-hand side) includes inoperable cells in the 5^{th} and 7^{th} bit positions from the left. Thus, the cells or bits identified by column labels 1-4, 6, and 8 through M are available for assignment as desired.

As shown in FIG. 2B, several additional bits or storage locations are inoperable when compared to the map 200a of FIG. 2A. The map 200b is a record of the same sets of registers shown in FIG. 2A operating under a different condition or conditions. For example, the map 200b represents bits or storage locations that are both operative (unmarked) and inoperative (marked) at a lower input voltage than the input voltage that resulted in the map 200a in FIG. 2A. As described in association with the map 200a in FIG. 2A, the operative cells in the map 200b are available for assignment to support one or more flags or single bit storage elements to one or more reduced cell registers having any number of contiguous operative cells as may be desired.

FIG. 2C includes a map 200c that represents bits or storage locations that are both operative (unmarked) and inoperative (marked) as a result of a signal or signals communicated from the cell controller 130. As described, the cell controller 130 actively de-energizes a subset of the cells of one or more of the N registers to provide one or more reduced cell registers to one or more of the decoder 112, the register file manager 114 and/or the operand manager 300. In the illustrated embodiment, the cell controller 130 has de-energized a byte corresponding to the left-most storage locations of the N registers. It should be understood that the cell controller 130 can be arranged to mark more or less bits than a byte for any one of the N registers in any desired combination.

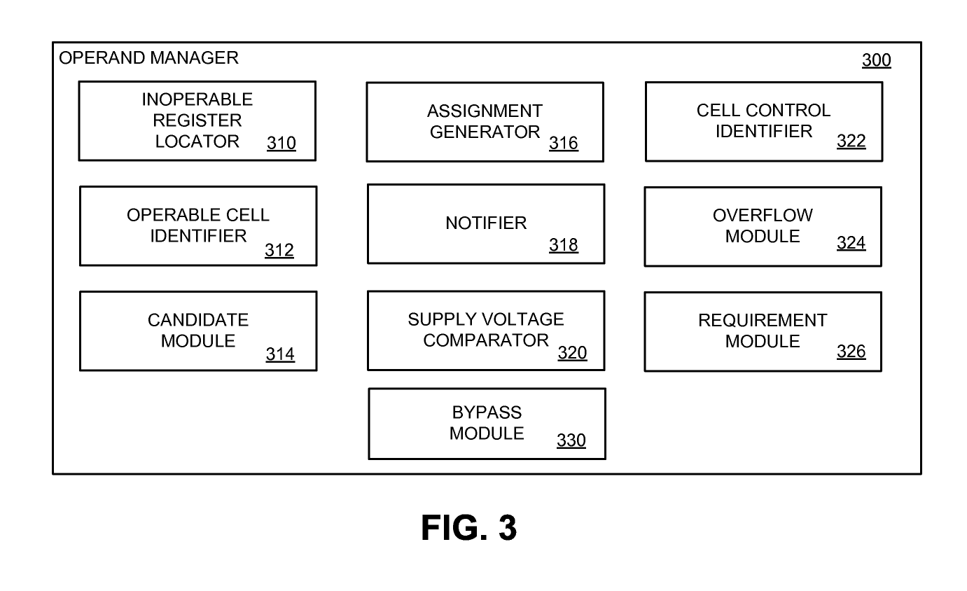

FIG. 3 is a schematic diagram illustrating an embodiment of the operand manager 300 of FIG. 1. As illustrated in FIG. 3, the operand manager 300 includes various circuits, sub-assemblies or modules that are arranged to perform one or more tasks in the improved instruction processing system. In the illustrated embodiment, the operand manager 300 includes an inoperable register locator 310, an operable cell identifier 312, a candidate module 314, an assignment generator 316, a notifier 318, a supply voltage comparator 320, a cell control identifier 322, an overflow module 324, a requirement module 326 and a bypass module 330. The inoperable register locator 310, is a circuit or assembly of circuits arranged to locate or otherwise identify at least one member from a set of available registers having at least one inoperable cell among the cells forming the at least one member register. As indicated, an inoperable cell is a cell that cannot be directed to a desired condition (e.g., to store or hold a voltage level corresponding to a defined logical value) or is unable to hold or store the desired condition under present conditions.

The inoperable register locator 310 may be controllably activated in response to an indication that the regulated (or an unregulated) supply voltage has fallen below a desired input voltage. Alternatively, the inoperable register locator 310 may be controllably activated in response to a signal from the supply voltage comparator 320 indicating that the regulated supply voltage supplying the registers and/or other circuits in the instruction processing system 100 has changed by more than a threshold amount. In another alternative, the inoperable register locator 310 may be controllably activated in response to a controller that de-energized at least one cell in the set of available registers. When such a controller de-energizes a block or blocks of cells, the inoperable register locator 310 may be directed to only check the operability of the cells that were not controllably de-energized. However applied, results provided by the inoperable register locator 310 are used to populate the register cell map 200. The operable cell identifier 312 is a circuit or assembly of circuits arranged to confirm or otherwise identify a subset of cells in a M-bit register that can be directed to a desired condition.

The candidate module 314 includes circuits arranged to identify valid candidates. The operand manager uses instructions and other information from these elements when determining how to appropriately pair a register with a set of operable cells and a set of inoperable cells. For example, the operand manager may use the present instruction in the current instruction register to analyze the immediate operands. An immediate operand that includes a value (e.g., an integer) that can be supported in less than M bits is a candidate to be supported by a physical register with less than a complete set of operable cells.

In addition, the operand manager may use the current value of a register to determine that the register is a candidate to be supported by a register with less than a complete set of operable cells. The operand manager can use information from the register file manager to make such a determination. For example, the current instruction register of the instruction processing system may include an instruction that directs the register file manager to move the content in a first register to a second register. When the content in the first register includes a value that can be supported in less than M bits, the second register is a candidate to be supported by a physical register with less than a complete set of operable cells.

The assignment generator 316 is a circuit or collection of circuits under the control of the operand manager 300 that associate a select storage cell or set of contiguous operable storage cells to use as an assigned storage location for an operand. The assignment remains active until the operand stored therein is cleared or power is removed from the instruction processing system 100.

The notifier 318 is a circuit or collection of circuits under the control of the operand manager 300 that signal the register file manager 114 and/or the register file 120 of the assignment generated by the assignment generator 316.

The cell control identifier 322 identifies when a controller such as the optional cell controller 130 has signaled or otherwise directed that some number of otherwise operable cells should be disabled, or de-energized from the otherwise available number of cells in a desired number of registers to achieve a desired power savings. In this arrangement, the cell control identifier 322 may provide configuration information or signals indicative of an array of cells that were de-energized to the operand manager. Such an array can define a set of operable/inoperable cells in a single physical register or a set of similarly positioned operable/inoperable cells in two or more of the available physical registers.

The overflow module 324 is a circuit or collection of circuits that in response to an overflow condition received from the ALU 108 or other sources in the instruction processing system 100 generate appropriate signals to avoid and/or correct the overflow condition by reassigning the storage resources that are available to support the ALU 108. As a part of the reassigning, the operand manager 300 may notify or otherwise communicate that a remapping (of the register array 122) is required to the register file manager 114.

The requirement module 326 is a circuit or collection of circuits arranged to identify the number of cells or bits will be required to adequately support a likely result from the present instruction being processed by the instruction processing system 100.

The bypass module 330, in response to an input signal, de-energizes the operand manager 300 and the various sub-assemblies and modules thereof When the operand manager 300 is bypassed or commanded off, the instruction processing system 100 assigns registers in a conventional manner.

The operand manager 300 may use several distinct mechanisms to identify potential candidate operands that may be supported by a reduced cell register. For example, the operand manager 300 may respond to a value stored in or both of the accumulator 104 and the temporary register 106 to make such a determination. Alternatively, and/or additionally the operand manager 300 may use an output of the ALU 108 to determine if the operand is a suitable candidate for a reduced cell register.

In some embodiments, the instruction register 110 and the decoder 112 may be arranged to support a compiler by recognizing and forwarding an indication that an identified instruction can be supported with a reduced cell register. These circuit elements and the compiler they support may further indicate a desired number of cells required for the modified operand. When this is the case, the decoder 112 may forward an indication via a signal that the present instruction is a candidate for support with a register having less than M operable cells. In some arrangements, the decoder 112 may be arranged to communicate the desired minimum number of cells to support an operand for the present instruction.

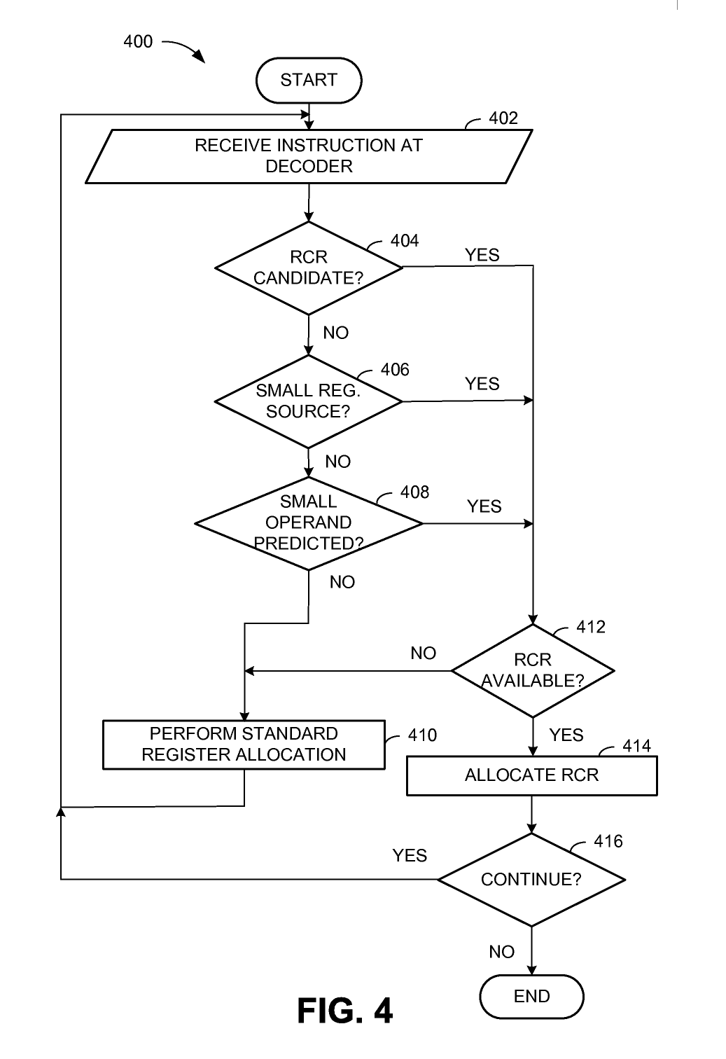

FIG. 4 is a flow chart illustrating an embodiment of a method 400 for allocating operands to sets of operable cells in the available registers of FIGS. 2A-2C that may be implemented by the reduced cell register coordinator 160 illustrated by way of broken line in the instruction processing system 100 of FIG. 1. The method 400 begins with input block 402 where an instruction is received at a decoder (e.g., the decoder 112 of FIG. 1). A series of respective queries are performed as indicated in decision block 404, decision block 406 and decision block 408. In decision block 404, the decoder 112 determines if the present instruction identifies or includes a small immediate operand. A small immediate operand is an operand that requires less than M bit cell locations to represent the present value associated with the operand. When the response to the query in decision block 404 is negative, the decoder 112 continues by determining whether the instruction identifies a register source that is using (i.e., a present value) less than M bit or cell locations. When the response to the query in decision block 406 is negative, the decoder 112 continues by determining whether a small operand is predicted (e.g., a value predictor may receive one or more signals or other indicators to predict that a result of the instruction will likely fit within a set of bit locations that is less than M bit locations. When the response to the query in decision block 408 is negative, the decoder 112 continues by directing the register file manager or register renaming logic enabled in the decoder 112 or one or more of the operand manager 300 or the register file manager 114 to allocate a next available fully operational register to support the operand, as indicated in block 410. Upon completion of the allocation in block 410, the decoder 112 may repeat the functions illustrated in the blocks 402 through 408.

As indicated in FIG. 4, an affirmative response to any of the separate queries in decision block 404, decision block 406, or decision block 408 is followed by an additional query, as indicated in decision block 412, to determine if a reduced cell register is available. When a reduced cell register is available, one or more of the operand manager 300 or the register file manager 114 may be configured to allocate an available and suitably sized reduced cell register for supporting the operand, as shown in block 414. Thereafter, a determination is made whether to continue or to terminate the method 400. When it is desired to continue, the method 400 repeats the functions described in association with blocks 402 through 414, as described. Otherwise, the method 400 terminates and the decoder 112 no longer identifies instructions with a short operand that can be supported by a register with less than a full set of operable bit cell locations.

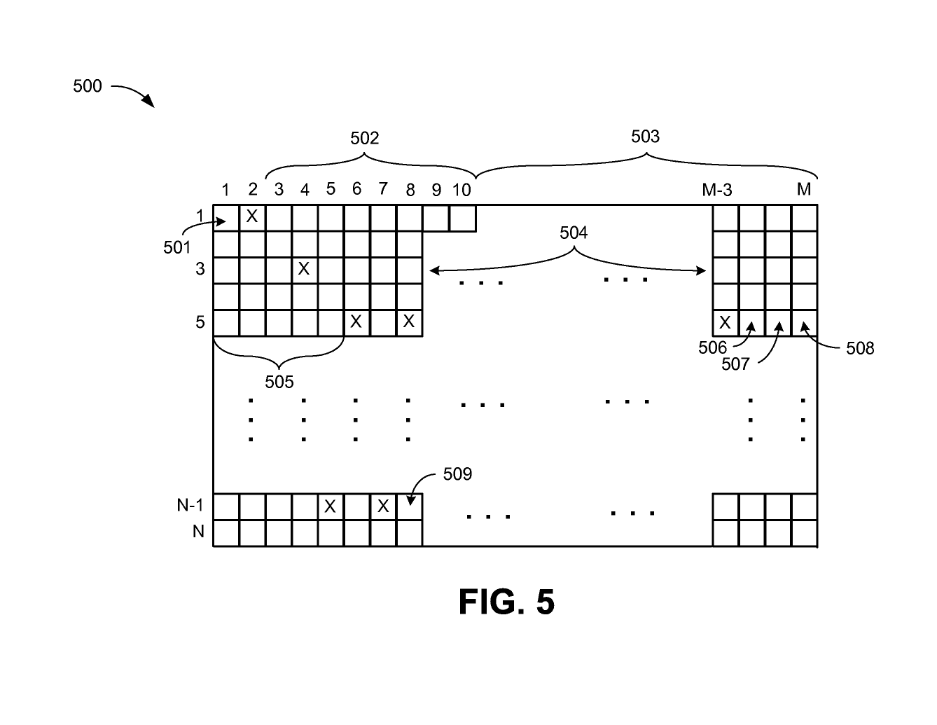

FIG. 5 is a schematic diagram illustrating a collection of sets of operable cells available to support modified or short operands with the operand manager of FIG. 3. As illustrated in FIG. 5, the representation or map 200a of N registers of M bits, as introduced in FIG. 2A with inoperable cells scattered throughout the N registers provides opportunities in registers identified by labels 1, 3, 5 and N-1 for assignments of one or more reduced cell registers or storage locations. In the illustrated embodiment, operative cells in rows of M bits including at least one inoperative bit are assigned to reduced cell registers.

For example, in the M bits in the first row from the top, in the revised map 500, a one-bit flag 501 is assigned to left-most storage cell of the first row, an eight bit register 502 or byte is assigned to bits 3 through 10, and bit locations 11 through M are assigned to reduced cell register 503. By way of further example, as shown in row 3, operative bits or cells identified by column labels 5 through M are assigned to reduced cell register 504. Although cells in the first three cell locations are operative they are not assigned in the illustrated embodiment.

In row 5, operative cells in the first five cell locations are assigned to reduced cell register 505 and each of the last three individual cell locations are assigned to a flag 506, flag 507 and flag 508. Although the cell in the seventh position from the left in row 5 is operative the cell is not assigned in the illustrated embodiment.

By way of additional example, in the row identified by the label N-1, the operative cell in bit location 8 is assigned to a flag 509. Although the cells in the first 4 bit locations, the sixth position, and in bit positions nine through M in row N-1 are operative the cells in those locations are not assigned either to flags or other reduced cell registers in the illustrated embodiment.

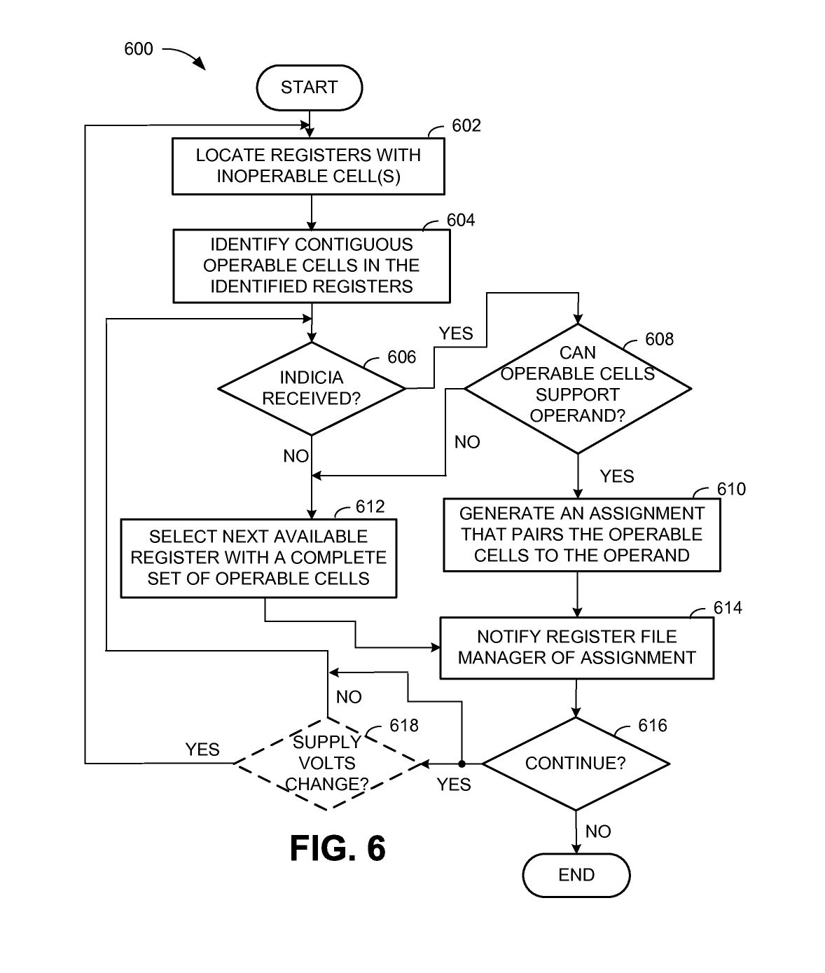

FIG. 6 is a flow chart illustrating an embodiment of a method 600 for adaptively managing registers in the instruction processing system 100 of FIG. 1. The method 600 may be implemented by the operand manager 300 in conjunction with the register file manager 114 and the register file 120. Alternatively, the method can be extended to apply the above-described changes to renaming logic to identify and manage reduced cell registers in other storage elements coupled to the instruction processing system 100.

The method 600 begins with block 602 where registers with inoperable cells are located or otherwise identified. As described, this can be accomplished by various circuits arranged to controllably write logical values to and read logical values from the separate bit locations of an N-bit register. In block 604, for registers with inoperable bit locations, contiguous operable bit locations are identified and recorded. In decision block 606, it is determined when indicia is received that an operand with less than the nominal number of bit locations in a register will be needed. As indicated by the flow control arrow labeled “No,” exiting decision block 606, when no indicia of a short operand is present, the improved instruction processor 100 selects the next available register with a complete set of operable cells, as indicated in 612. Thereafter, the instruction processor 100 associates or assigns the operand to the identified register and notifies the register file manager of the assignment, as indicated in block 614.

Otherwise, as indicated by the flow control arrow labeled “Yes,” exiting decision block 606, when indicia of a short operand is present, it is determined in decision block 608 if operable cells are available to support the short operand. For example, if the indicia indicate that a short operand will require at least P-bits to support the short operand, where P is a positive integer less than M, the query in decision block 608 will determine if an otherwise inoperable register includes a contiguous set of at least P bit locations. When an inoperable register includes a contiguous set of at least P bit locations, as indicated in block 610, the instruction processor 100 generates an assignment that pairs the operand to the operable cells or bit locations before notifying the register file manager of the assignment or pairing, as indicated in block 614.

Otherwise, when no sets of operable cells of an identified inoperable complete or full register will support the short operand, the method 600 continues with block 612 where the next available register with a complete set of operable cells is assigned or paired with the operand before notifying the register file manager of the assignment, as shown in block 614. Whether a modified or short operand was supported by a reduced capacity register or a fully operational register, as indicated in decision block 616, a determination is made whether to continue or to terminate the method 600. When it is desired to continue, the method 600 repeats the functions described in association with blocks 606 through 616, as described. Optionally, as indicated in decision block 618, when a change to the supply voltage has occurred, the method 600 will repeat the functions illustrated in block 602 and block 604 before looking for indicia of a short operand. Otherwise, when the supply voltage has not changed and/or exceeded a threshold change, processing continues with the functions described in conjunction with blocks 606 through 616.

Certain steps in the processes or process flows described in this specification naturally precede others for the improved instruction processing system to function as described. However, the instruction processing system is not limited to the order of the steps described if such order or sequence does not alter the described functionality. That is, it should be recognized that some steps may performed before, after, or parallel (substantially simultaneously with) other steps without departing from the disclosed methods. In some instances, certain steps may be omitted or not performed without departing from the method as understood by one of ordinary skill in the art. Further, words such as “thereafter,” “then,” “next,” etc., are not intended to limit the order of the steps. These words are simply used to guide the reader through the description of the exemplary method.

In view of the disclosure above, one of ordinary skill in programming is able to write computer code or identify appropriate hardware and/or circuits to implement the disclosed systems and methods without difficulty based on the schematic diagrams, flow charts and associated description in this specification. Therefore, disclosure of a particular set of program code instructions or detailed hardware devices is not considered necessary for an adequate understanding of how to implement and use the improved instruction processing system.

As described, in one or more exemplary aspects, the improved instruction system may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A non-transitory storage media may be any available media that may be accessed by the instruction processing system. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the scope of the present systems and methods, as defined by the following claims.

What is claimed is:

1. A method for adaptively managing registers in a processor, the method comprising:
locating at least one member register from a set of available registers having at least one inoperable cell among the cells forming the at least one member register;
identifying a set of operable cells in the at least one member register that has at least one inoperable cell;
in response to an indication that an operand can be supported by less than a nominal number of cells, determining if the set of operable cells in the at least one member register that has at least one inoperable cell can support the operand; and
in response to determining that the set of operable cells in the at least one member register that has at least one inoperable cell can support the operand:
generating an assignment that logically couples the set of operable cells to the operand; and
notifying a register file manager of the assignment.

2. The method of claim 1, wherein the locating at least one member register from the set of available registers having at least one inoperable cell is responsive to a first input voltage.

3. The method of claim 2, wherein the locating at least one member register from the set of available registers having at least one inoperable cell is responsive to a second input voltage lower than the first input voltage.

4. The method of claim 1, wherein the locating at least one member register from the set of available registers having at least one inoperable cell is responsive to a controller that de-energized at least one cell in the set of available registers.

5. The method of claim 1, wherein identifying the set of operable cells in the at least one member register is responsive to a controller that de-energized at least one cell in the set of available registers.

6. The method of claim 1, wherein the determining if the set of operable cells can support the operand is responsive to a decoder arranged to analyze a present instruction.

7. The method of claim 1, wherein the determining if the set of operable cells can support the operand is responsive to a stored value.

8. The method of claim 1, wherein the determining if the set of operable cells can support the operand is further responsive to an output of an arithmetic logic unit.

9. The method of claim 8, wherein when the output of the arithmetic logic unit is an indication of an overflow condition, an operand manager responds by notifying a register file manager that a remapping is required.

10. The method of claim 1, wherein the determining if the set of operable cells can support the operand is responsive to a compiler arranged to forward an indication that an identified instruction can be supported with a modified operand.

11. The method of claim 10, wherein the compiler indicates a required number of cells to support the modified operand.

12. An instruction processing system for adaptively managing a set of available registers, the system comprising:
a set of available registers including N members of M cells, where N and M are positive integers, and wherein at least one of the M cells of an identified member register of the set of N registers is inoperable;
an operand manager coupled to the set of available registers and arranged to:
identify a set of operable cells in the identified member register,
determine if the set of operable cells in the identified member register can support an operand; and
in response to determining that the set of operable cells in the identified member register can support the operand:
generate an assignment that logically couples the set of operable cells to the operand and notify a register file manager of the assignment.

13. The system of claim 12, wherein the set of available registers is provided a variable supply voltage.

14. The system of claim 13, wherein the operand manger, in response to a change in the supply voltage, identifies changes in the set of operable cells.

15. The system of claim 12, wherein the operand manager is responsive to an array of controllably de-energized cells.

16. The system of claim 12, wherein the operand manager is responsive to a decoder arranged to analyze a present instruction and forward an indication that the present instruction is a candidate for support with a register having less than M operable cells.

17. The system of claim 17, wherein the decoder further communicates a desired number of cells to support an operand identified in the present instruction.

18. The system of claim 12, wherein the operand manager is responsive to an indication of an overflow condition and wherein the response includes signaling a register file manager that a remapping is required.

19. The system of claim 12, wherein the operand manager is responsive to a compiler modified instruction indicating that the instruction can be supported with a modified operand.

20. The system of claim 19, wherein the compiler indicates a desired number of operable cells.
